(19) United States
(12) Patent Application Publication
(10) Pub. No.: US 2013/0215492 A1
(43) Pub. Date: Aug. 22, 2013

(54) ELECTROWETTING DEVICES ON FLAT AND FLEXIBLE PAPER SUBSTRATES

(71) Applicants: Andrew J. Steckl, Cincinnati, OH (US); Duk Young Kim, Hwaseong-si (KR)

(72) Inventors: Andrew J. Steckl, Cincinnati, OH (US); Duk Young Kim, Hwaseong-si (KR)

(73) Assignee: University of Cincinnati, Cincinnati, OH (US)

(21) Appl. No.: 13/807,867

(22) PCT Filed: Jun. 30, 2011
(86) PCT No.: PCT/US11/42570

§ 371 Date: Mar. 13, 2013

Related U.S. Application Data
(60) Provisional application No. 61/360,096, filed on Jun. 30, 2010.

(51) Int. Cl. G02B 26/00; B05D 5/12

(52) U.S. Cl. CPC G02B 26/005; B05D 5/12
USPC 359/290; 427/58

(57) ABSTRACT

Electro wetting devices and methods. The electro wetting device 10 includes a grounded electrode 14 on one side of a paper substrate 12. A dielectric layer 16 and a hydrophobic film 20 are sequentially layered onto the grounded electrode 14. The hydrophobic film 20 is configured to impart a contact angle on a polar liquid 18. A polar liquid 18 is in contact with the hydrophobic film 20 and a voltage source 22 couples the grounded electrode 14 to the polar liquid 18. When an electric field is applied by the voltage source 22, the contact angle of the polar liquid 18 decreases.

### CROSS-REFERENCE TO RELATED APPLICATIONS

This application claims the benefit of U.S. Provisional Patent Application Ser. No. 61/360,096 (pending), the disclosure of which is incorporated by reference herein, in its entirety.

### STATEMENT REGARDING FEDERALLY SPONSORED RESEARCH OR DEVELOPMENT

The U.S. Government has a paid-up license in this invention and the right, in limited circumstances, to require the patent owner to license the same to others on reasonable terms, as provided by the terms of Grant No. ECCS-0725530 awarded by the National Science Foundation.

### FIELD OF THE INVENTION

The present invention relates generally to electrowetting devices and methods of manufacturing an electrowetting device.

### BACKGROUND OF THE INVENTION

Paper is a highly versatile product that has been in widespread use for centuries. Paper has been used for writing, printing, packaging, cleaning, and as money. To make paper, fibers of the main ingredient, polysaccharide polymer (cellulose), variable in length, diameter, and density and are layered in a random network. As water is then removed from the fibers, surface tension brings the fibers into close proximity such that hydrogen bonds form between adjacent fibers. When dry, these hydrogen bonds give paper its characteristic high tensile strength. However, when water is introduced to dry paper, the hydrogen bonds are broken and the fibers disperse, which gives paper its recyclable nature.

Because of its wide availability in various formulations, flexibility, low cost, biosynthesis, and biodegradability, interest in developing paper as a substrate has increased. Paper has already been used to form biofluidic devices to transport liquids, fluidic switches, energy storage (e.g., batteries), and temperature displays using the thermochromic effect.

Display devices require certain characteristics: fast response time, operation with a low voltage, and low power consumption. Conventional electronic display devices used in electronic reader products have operated as electrophoretic (“EPh”) displays or as liquid crystal displays (“LCD”). EPh displays operate by the movement of titanium dioxide particles within oil in response to the localized change in charge between the two electrodes. However, EPh is limited to monochrome displays and is not capable of producing the switching speeds that are necessary for video. LCDs require a backlight and consume more power than EPh displays.

Electrowetting (“EW”), the effect that an electric field has on the wetting of solids, has been shown to be a particularly useful effect able to provide desired display characteristics: high switching speed for video operation and low power operation. EW displays have been operated in accordance with the competitive electrowetting effect, where an applied voltage induces a change in the contact angle of an aqueous electrolyte drop that is surrounded by a nonpolar liquid on a hydrophobic surface.

Therefore, methods and electrowetting devices are needed that combine the potential benefits of paper-based electronic products and displays (including foldability and low cost) with the switching speeds, low voltage operation, low power consumption, and color variation of conventional electrowetting devices.

### SUMMARY OF THE INVENTION

In accordance with one embodiment of the invention, an electrowetting device has a grounded electrode on one side of a paper substrate. A dielectric layer and a hydrophobic film are sequentially layered onto the grounded electrode. The hydrophobic film is configured to impart a contact angle on a polar liquid. A polar liquid is in contact with the hydrophobic film and a voltage source couples the grounded electrode to the polar liquid. When an electric field is applied by the voltage source, the contact angle of the polar liquid decreases.

According to another embodiment of the invention, an electrowetting device has a grounded electrode on a first side of a paper dielectric and a hydrophobic film on the opposing, second side of the paper dielectric. The hydrophobic film is configured to impart a contact angle on a polar liquid. A polar liquid is in contact with the hydrophobic film and a voltage source couples the grounded electrode to the polar liquid. When an electric field is applied by the voltage source, the contact angle of the polar liquid decreases.

In accordance with another embodiment of the invention, a method of constructing an electrowetting device includes depositing an electrode onto one side of a paper substrate with a dielectric layer and a hydrophobic film sequentially layered thereon. A polar liquid is placed into contact with the hydrophobic film, and an electrical connection formed between the polar fluid and the electrode.

In accordance with another embodiment of the invention, a method of constructing an electrowetting device includes depositing an electrode onto a first side of a paper dielectric and a hydrophobic film is coating onto a second, opposing side of the paper dielectric. A polar liquid is placed into contact with the hydrophobic film, and an electrical connection is formed between the polar fluid and the electrode.

In accordance with one embodiment of the invention, an electrowetting display device includes a paper substrate and a grounded electrode on one side of a paper substrate. A dielectric layer and a hydrophobic film are sequentially layered onto the grounded electrode. The hydrophobic film is configured to impart a contact angle on a polar liquid. A masked photoresist layer on the hydrophobic film forms a plurality of pixels. A plurality of volumes of a polar liquid is positioned into each of the plurality of pixels. When an electric field is applied to at least one of the plurality of volumes by the voltage source, the contact angle of the at least one volumes decreases.

In accordance with one embodiment of the invention, an electrowetting display device includes a grounded electrode on a first side of the paper dielectric and a hydrophobic film on the second, opposing side of a paper dielectric. The hydrophobic film is configured to impart a contact angle on a polar liquid. A masked photoresist layer on the hydrophobic film forms a plurality of pixels. A plurality of volumes of a polar liquid is positioned into each of the plurality of pixels. When an electric field is applied to at least one of the plurality of volumes by the voltage source, the contact angle of the at least one volumes decreases.

In accordance with another embodiment of the invention, a method of constructing an electrowetting display device includes deposition an electrode onto one side of a paper substrate with a dielectric layer, a hydrophobic film, and a photoresist layer sequentially layered thereon. The photoresist layer is masked and developed to form a plurality of pixels. A volume of a polar liquid is placed in each of the plurality of pixels and in contact with the hydrophobic film. An electrical connection is made between at least one of the volumes and the electrode, the latter of which is grounded.

In accordance with another embodiment of the invention, a method of constructing an electrowetting display device includes deposition an electrode is deposited onto a first side of a paper dielectric and a hydrophobic film and a photoresist layer are sequentially layered on a second, opposing side of the paper dielectric. The photoresist layer is masked and developed to form a plurality of pixels. A volume of a polar liquid is placed in each of the plurality of pixels and in contact with the hydrophobic film. An electrical connection between at least one of the volumes of the polar fluid and the electrode is formed with the electrode being grounded.

### BRIEF DESCRIPTION OF THE DRAWINGS

The accompanying drawings, which are incorporated in and constitute a part of this specification, illustrate various embodiments of the invention and, together with a general description of the invention given above and the detailed description of the embodiments, serve to explain the embodiments of the invention.

FIG. 1A is a cross-sectional diagrammatic view of an electrowetting device in accordance with one embodiment of the invention.

FIG. 1B is a cross-sectional diagrammatic view that is similar to FIG. 1 but for an application of a voltage that reduces the contact angle for the polar liquid.

FIG. 2A is a cross-sectional diagrammatic view of an electrowetting cell within a two-dimensional array electrowetting display device in accordance with another embodiment of the invention.

FIG. 2B is a top view of the two-dimensional array electrowetting display device of FIG. 2A.

FIG. 3A is a cross-sectional diagrammatic view that is similar to FIG. 2A but for an application of a voltage that reduces the contact angle for the polar liquid and displaces the non-polar liquid.

FIG. 3B is a top view that is similar to FIG. 2B but with the application of the voltage as shown in FIG. 3A.

FIG. 4A is a cross-sectional diagrammatic view of an electrowetting device having a tubular shape in accordance with another embodiment of the invention.

FIG. 4B is a cross-sectional diagrammatic view that is similar to FIG. 4A but with the application of a voltage that reduces the contact angle for the polar liquid.

FIG. 5 is a side-elevational view of an electrowetting device having a curved surface in accordance with another embodiment of the invention.

FIG. 6 is a cross-sectional diagrammatic view of an electrowetting device in accordance with another embodiment of the invention.

FIG. 7 is a graph demonstrating the change in contact angle with applied voltage for each of four electrowetting devices constructed with different substrates and in accordance with an Example herein.

FIG. 8 is a graph demonstrating the change in contact angle in response to a 40 V square wave for each of four electrowetting devices constructed with different substrates and in accordance with an Example herein.

### DETAILED DESCRIPTION OF THE INVENTION

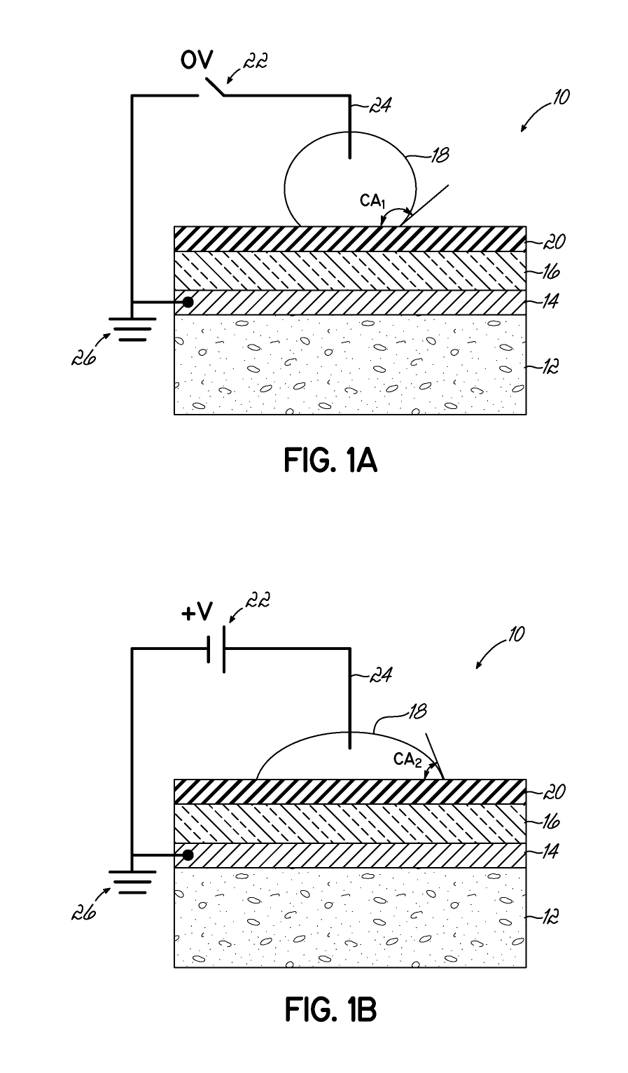

Turning now to the figures, and in particular to FIGS. 1A and 1B, one embodiment of an electrowetting device 10 is described as including a substrate 12 comprised of a paper product. While various paper products may be used, it may be desirable to use paper products having a surface roughness that approximates glass because glass has been the substrate of conventional electrowetting devices. However, as provided in greater detail below, other paper products may be used depending on the desired switching speed.

The substrate 12 may vary in thickness depending on the particular application. Generally, the substrate 12 should be thick enough to support the layers applied thereto and to provide insulation but not so thick as to limit the foldable nature of the paper. Suitable paper products range in thickness from about 40 μm to about 250 μm and may include commercially-available or custom-made products, such as glassine paper, Kromekote paper (10 point C1S glass paper, Mohawk Fine Papers, Cohoes, N.Y.), and Sappi paper (Sappi Ltd, Boston, Mass.).

An electrode 14 is deposited onto one side of the substrate 12. While any conductive material may be used as the electrode, copper (“Cu”) and indium tin oxide (“ITO”) are particular beneficial in conductance and ease of deposition. That is, the Cu and ITO electrodes may be deposited by sputter deposition, electroplating, or other methods that are known to those of ordinary skill in the art.

A dielectric layer 16 is then applied to the electrode 14 and is operable as an insulator between the electrode 14 and a polar liquid droplet 18. The dielectric layer 16 may be comprised of an inorganic compound, such as alumina (“Al₂O₃”) or silica (“SiO₂”), or organic compound, such as parylene. The thickness of the dielectric layer 16 is generally inversely proportional to the effective surface energy of the device 10 at a given applied voltage. For example, a thin dielectric layer 16 yields a higher surface energy that imparts a smaller contact angle on the droplet 18 for a given applied voltage as compared to a thick dielectric layer.

The surface energy of the device 10 is further configured to achieve the electrowetting response by adding a hydrophobic film 20 over the dielectric layer 16. The hydrophobic film 20 may include any sufficiently hydrophobic material that may be deposited, dip-coated or otherwise applied to the dielectric layer 16 without damaging the underlying paper substrate 12. Examples of suitable hydrophobic materials may include, for example, fluorinated compounds, such as TEFLON or FLUOROPEL, silicone compounds or fatty acids. To improve adhesion between the hydrophobic film 20 and the dielectric layer 16, the device 10 may be annealed, for example, at 130° C. for 10 min.

Referring still to FIGS. 1A and 1B, the droplet 18 comprised of the polar liquid is applied to and contacts the hydrophobic film 20 of the device 10. A voltage source 22 is electrically coupled to the droplet 18 via an electrode 24 and to the electrode 14, the latter of which is also grounded 26. The voltage source 22 may be comprised of a direct voltage source, a locally generated voltage, or a current source, such as thin-film transistors. Numerous direct, alternating, or other types of voltage sources are known to those skilled in the art of displays or microfluidic devices. The voltage source 22 may be biased by 0 V, a positive direct current (“DC”) voltage, a negative DC voltage, or an alternating current (“AC”) voltage, or other as appropriate. With AC voltage sources, various waveforms may be used, such as square-wave or sinusoidal or others as would be known to those of ordinary skill in the art.

Referring specifically to FIG. 1A, with a switch in the open position, effectively 0 V is applied and the hydrophobic film 20 imparts a high contact angle (illustrated as “CA₁”) on the droplet 18. However, when a positive DC voltage, a negative DC voltage, or an AC voltage across the droplet 18 and the electrode 14, the hydrophobic film 20 imparts a smaller contact angle (illustrated as “CA₂”) as compared to CA₁ of FIG. 1A, and the droplet 18 wets the surface of the hydrophobic film 20.

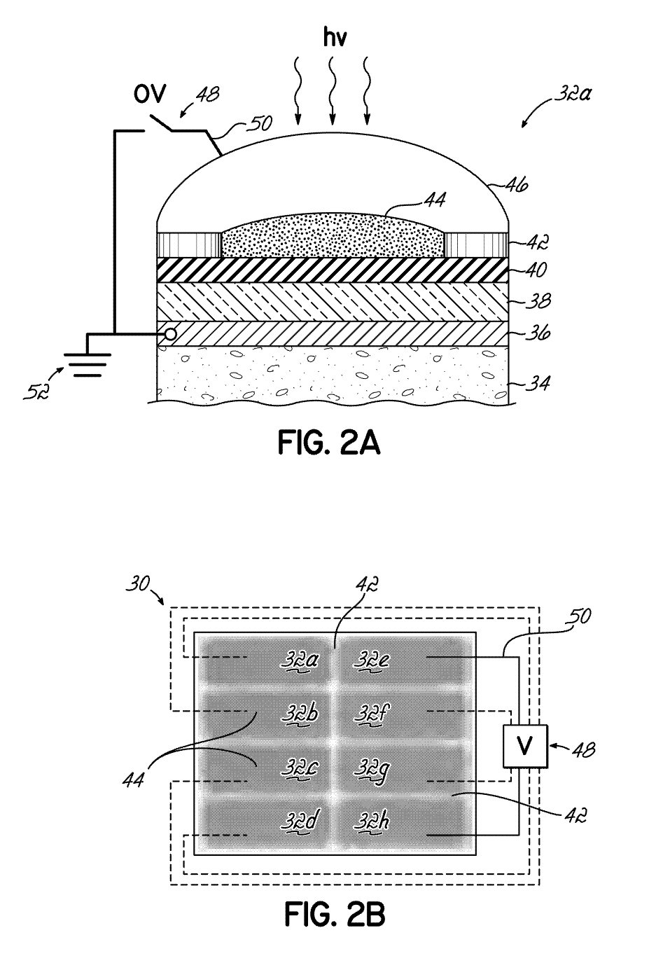

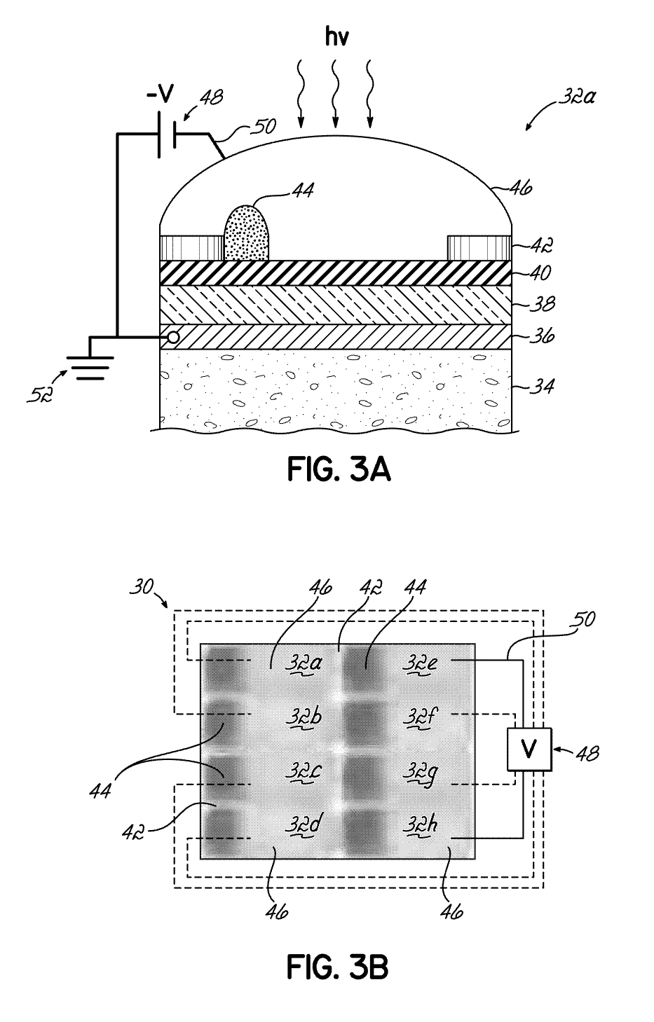

Turning now to FIGS. 2A-3B, an electrowetting display device 30 having a plurality of electrowetting cells 32a-32h, which may be a plurality of displayed pixels, is described in detail. One exemplary electrowetting cell 32a is shown in cross-section in FIG. 2A and includes a series of layers that include a paper-based substrate 34, an electrode 36, a dielectric layer 38, and a hydrophobic film 40. The plurality of electrowetting cells 32a-32h, shown here as a two-dimensional array of 4×2 cells, is formed by applying and developing a photoresist layer 42 onto the hydrophobic film 40. In accordance with one embodiment, a masked SU-8 photoresist layer 42 is applied to the hydrophobic film 40 and developed with ultraviolet light (i.e., λ=365 nm). Each portion masked and remaining undeveloped forms one of the electrowetting cells 32a-32h and is dosed with a volume shown herein as a droplet 44, of a nonpolar liquid, which may include a desired colorant. Colorants may include suitable pigments or dyes, some of which may be solid particles that are dispersed or dissolved in the nonpolar liquid, to alter at least one optical or spectral property of the nonpolar liquid. A polar liquid 46 is then applied over the droplet 44 of nonpolar liquid. It would be understood that the positions of the polar and nonpolar liquids may be reversed and/or the colorant may be applied to the polar liquid rather than the nonpolar liquid. Additionally, two colorants, one in each of the polar and nonpolar liquids, may be used.

For smooth electrowetting operation, the surface tension of the droplet 44 of the nonpolar liquid should be greater than the surface energy of the electrowetting cell 32a-32h (here, the hydrophobic film 40) but less than the polar liquid 46. In one embodiment, the droplet 44 may be comprised of dodecane, having a surface tension 25 mJ/m², applied to a FLUOROPEL hydrophobic film 40 with a surface tension of 16 mJ/m². For reference, the surface tension of deionized water, one exemplary polar liquid, is 72 mJ/m². Additionally, the viscosity of the droplet 44 of the nonpolar liquid should be similar to the viscosity of the polar liquid 46. Again, as an example, the viscosity of dodecane is 1.39 cP, which is similar to the viscosity of deionized water at 0.91 cP.

The voltage source 48 couples the polar liquid 46, via an electrode 50, to the electrode 36, which is also coupled to the ground 52. While only one voltage source 48 is shown, it would be understood that the voltage source may be comprised of a plurality of voltage sources, each of which couples the electrode 36 to the polar liquid of one of the plurality of electrowetting cells 32a-32h. In this way, one or more of the cells 32a-32h may be operated to provide a particular display, such as an alphanumeric or other symbol.

With no voltage applied, the electrowetting display device 30 is in a first state wherein the droplet 44 of the nonpolar liquid spans the surface of the hydrophobic film 40 and is bordered by the photoresist layer 42 so as to minimize the contact between the polar liquid 46 and the hydrophobic film 40. Light (illustrated as “hv”) may enter the electrowetting display device 30, through the fluids within each electrowetting cell 32a-32h, and is reflected at the electrode 36 (if constructed from a reflective material) or another reflective layer deposited within the device 30. Because the colorant is applied to the nonpolar liquid, the cells 32a-32h in the first state are observed as having the respective color.

When a voltage is applied (here a negative bias is illustrated) between the electrode 36 and the polar liquid 46, the electrowetting cell 32a-32h moves to a second state wherein the hydrophobic film 40 imparts a smaller contact angle on the polar liquid 46, and the polar liquid 46 wets the surface of the hydrophobic film 40. Said another way, the contact between the droplet 44 of the nonpolar liquid and the hydrophobic film 40 is minimized, which allows the polar liquid 46 to move into contact with the hydrophobic film 40. As a result, the color of the cells 32-32h in the second state will be observed to be the color of the polar liquid 46.

The response time for switching each electrowetting cell 32a-32h between the first and second state is related to the surface roughness of the paper substrate 34. Therefore, those substrates 34 having a surface roughness that is most like the conventional substrate of glass, that is, smooth, will have a response time that is most similar to glass. Surface roughness may range from about 2 nm to about 5 nm.

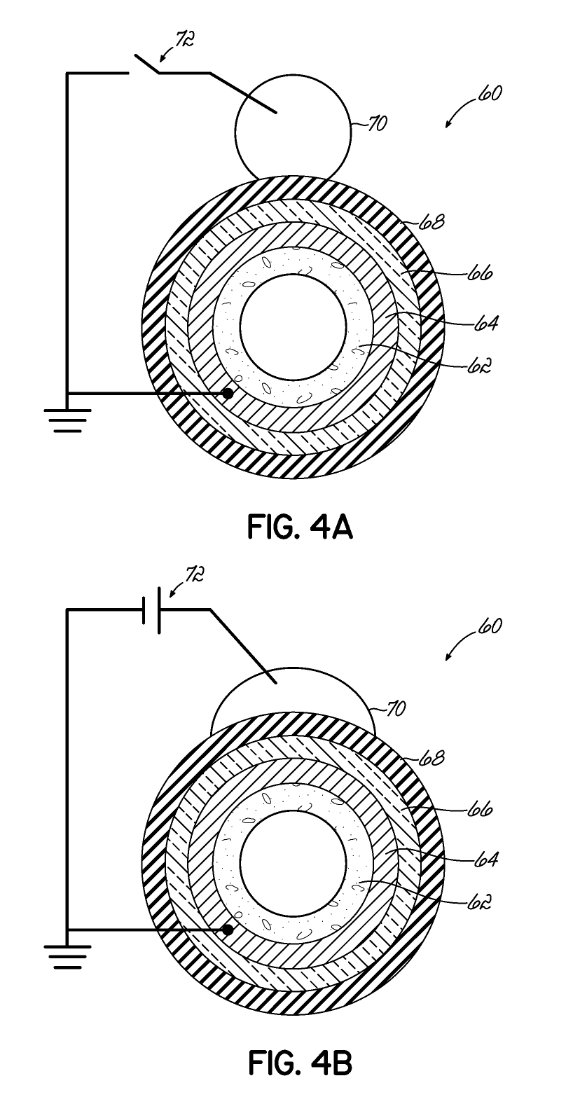

One particular benefit to the use of the paper as the substrate for an electrowetting device is that the electrowetting device may be folded or otherwise configured to a curved shaped. The foldable nature of paper also lends itself to the formation of packaging materials. Therefore, in FIGS. 4A and 4B, an electrowetting device 60 in accordance with another embodiment of the invention is shown and includes a paper substrate 62 that has been folded to form a tubular-shape with a substantially circular lateral cross-section. The device 60 further includes an electrode 64, a dielectric layer 66, and a hydrophobic film 68, which are layered onto the paper substrate 62 as was described in detail above.

In a first state, the droplet 70 of the polar liquid is suspended on the outer, curved surface of the device 60, adjacent the hydrophobic film 68. When a biasing voltage from the voltage source 72 is applied between the droplet 70 and the electrode 64, the droplet 70 wets the surface of the hydrophobic film 68, which is illustrated as the second state in FIG. 4B, by an amount that is proportional to the applied biasing voltage.

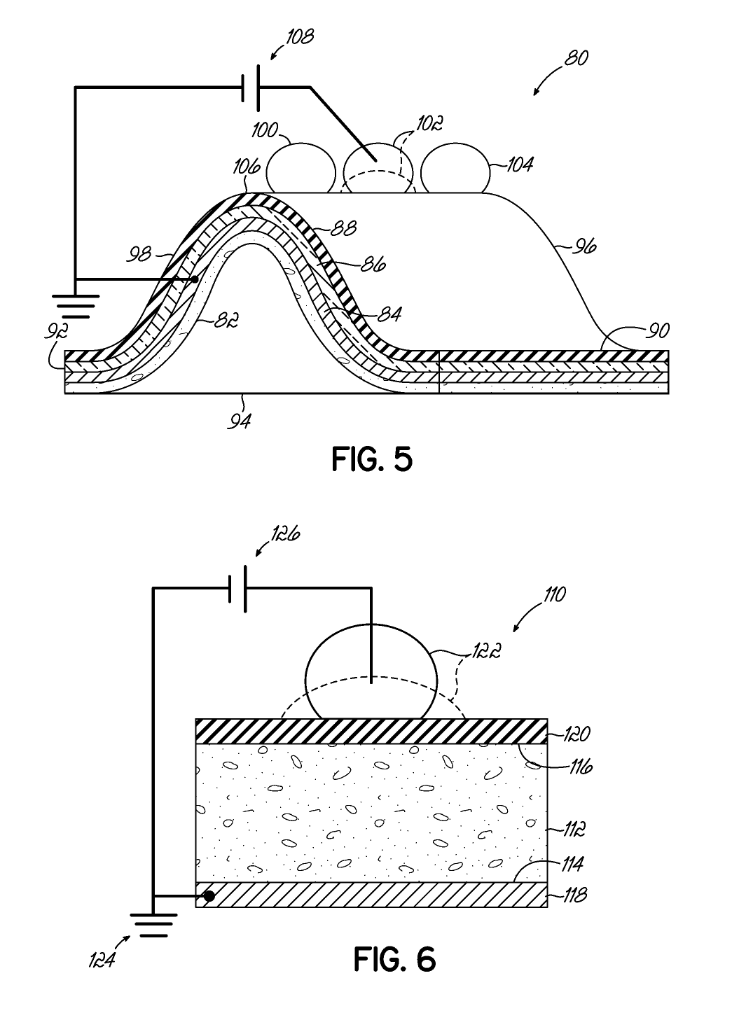

FIG. 5 illustrates an electrowetting device 80 according to another embodiment of the invention. The device 80 includes a paper substrate 82, a grounded electrode 84, a dielectric layer 86, and a hydrophobic film 88, which are layered as described in detail above. In this particular embodiment, first and second edges 90, 92 of the electrowetting device 80 reside within the same plane 94 while longitudinal edges 96, 98 curve upwardly and away from the plane 94. Three droplets 100, 102, 104 of polar liquid are positioned at an apex 106 of the curved portion. The droplets 100, 102, 104 may be comprised of the same or different polar liquids, include the same or different colorants, or a combination thereof. As shown, the second 102 of the three droplets 100, 102, 104 is electrically coupled to the grounded electrode 84 via the voltage source 108. Accordingly, when voltage is applied, the second droplet 102 moves from a first state (shown in solid) to a second state (shown in phantom) where the second droplet 102 wets the surface of the hydrophobic film 88. While the first and third droplets 100, 104 also reside on the hydrophobic film 88, only the second droplet 102, which is electrically coupled to the grounded electrode 84, will undergo electrowetting and transition between the first to the second states.

Turning now to FIG. 6 where an electrowetting device 110 in accordance with yet another embodiment of the invention is described and wherein the paper product is operable as a dielectric layer 112. More specifically, the dielectric layer 112, which may be comprised of any paper product as described previously, includes first and second opposing sides 114, 116. A metal electrode 118 is positioned on the first side 114 of the substrate 112 and a hydrophobic film 120 is positioned on the second side 116 of the substrate 112. The metal electrode 118 and the hydrophobic film 120 may be formed in a manner that is known in the art, including those that were discussed in detail above. A droplet 122 of a polar liquid is positioned on the hydrophobic film 120 and is electrically coupled to the metal electrode 118 (which is coupled to ground 124) via a voltage source 126.

In use, the device 110 is operable in a manner that is similar to the earlier described embodiments. That is, in a first state (shown in solid), the hydrophobic film 120 imparts a large contact angle on the droplet 122. When a biasing voltage is applied, the contact angle of the droplet 122 decreases as the droplet 122 moves into the second state (shown in phantom) and wets the surface of the hydrophobic film 120.

Further details and embodiments of the invention will be described in the following example.

### Example

Four tubular electrowetting devices were constructed in a manner similar to the electrowetting device 60 of FIG. 4A. Specifically, three paper substrate materials were tested, including glassine paper, Kromekote paper (10 point C1S glass paper, Mohawk Fine Papers, Cohoes, N.Y.), and Sappi paper (Sappi Ltd, Boston, Mass.). A glass substrate was used in the fourth tubular electrowetting device as a control. The properties of each type of paper are summarized in Table 1.

TABLE 1
Paper Properties

| | Glassine | Kromekote | Sappi |
|---|---|---|---|
| Thickness (μm) | 45 | 235 | 180 |
| Basis weight | 48 | 212 | 167 |
| (g/m²) | | | |
| Specific volume | 9.37 × 10⁻¹ | 1.11 × 10⁻⁶ | 1.08 × 10⁻⁶ |
| (m³/g) | | | |
| Water contact | 44.5 | 80.4 | 105.7 |
| angle (deg) | | | |
| Texture | Smooth, air and | | Ultra-smooth, |
| | water resistant | | hydrophobic surface |

A Cu electrode was deposited by sputtering (DV-602, Denton Vacuum, Moorestown, N.J.) onto the glassine and Kromekote paper substrate in argon at 3.5 mTorr (base pressure of 2.0×10⁻⁶ Torr) with 150 W radio-frequency power for 10 min resulting in a final Cu electrode thickness of 200 nm. An ITO electrode was deposited by sputtering in an argon and oxygen environment at 3.5 mTorr with 100 W direct-current (“DC”) power for 20 min resulting in a final ITO electrode thickness of 200 nm on the glass and Sappi paper substrates.

A dielectric layer was added to each electrode. The dielectric layer in this example was comprised of parylene and was deposited by a LABCOATER 2 parylene deposition unit (PDS 2010, Specialty Coating Systems, Indianapolis, Ind.) at room temperature. Two different thicknesses of the parylene layers were tested, 1 μm and 0.5 μm, both deposited using 0.8 g and 0.4 g, respectively, of a Parylene C starting material (Specialty Coating Systems, Indianapolis, Ind.) and with a starting pressure that was less than 15 mTorr.

Finally, a hydrophobic film consisting of FLUOROPEL (PFC1601 V, Cytronic Corp., Beltsville, Md.) was added to the dielectric layer. FLUOROPEL is a copolymer mixture of vinyl, perfluoropolyether, and urethane (with perfluoroalkyl groups) and was added to each device by dip-coating each device into a 1% solution of FLUOROPEL in fluorosolvent resulting in a 150 nm thick film on the device. The FLUOROPEL film dried for about one hour at room temperature in air and yielded a 16 mJ/m² surface energy. Subsequent annealing at 130° C. improved adhesion of the FLUOROPEL film to the underlying dielectric layer without damaging the paper substrate.

Scanning electron microscopy (“SEM”) and atomic force microscopy (“AFM”) were used to characterize the surface morphology of each paper substrate and the glass substrate before and after various layer depositions. SEM samples were prepared by deposition of a thin layer of gold onto each substrate and scanned with a scanning electron microscope (SX-40A, International Scientific Instruments, Inc., Pleasanton, Calif.). AFM scanning was performed on an atomic force microscope (Dimension Nanoscope, IV, Veeco, Plainview, N.Y.) in tapping mode. Surface roughness values (in nm) are provided in Table 2.

TABLE 2
Surface roughness (nm)

| | Glass | Glassine | Kromekote | Sappi |
|---|---|---|---|---|
| Paper substrate alone | <2 | ~300-400 | 42 | 2 |
| After electrode deposition | 3.8 | ~100-200 | 42 | 2.6 |
| After hydrophobic film | 4.9 | ~100-200 | 27 | 5.0 |
| deposition | | | | |

The glassine surface, as-received, exhibited randomly located smooth and rough regions. The Kromekote paper, as-received, included a fairly uniform distribution of small pores having a diameter that was less than about 1 μm. The Sappi paper, as-received, showed the smoothest surface morphology and was the closest to the surface morphology of glass.

The contact angle of the polar liquid with respect to the hydrophobic film of each device was measured by immersing each device into a container of dodecane oil (Acros Organics, Belgium). A 3 μL droplet of deionized water was then injected and the contact angle measured with a VCA Optima XE system (Advanced Surface Technology, Arvada, Colo.) with an external bias applied to the droplet through a wire connected to a function generator (AFG310, Tektronix, Beaverton, Oreg.) and a voltage amplifier (F10AD, FLC Electronics, Partille, Sweden). The initial contact angle in the first state on the 5 μL droplet was 44°, 80°, and 105° for the glassine, Kromekote, and Sappi paper substrates, respectively.

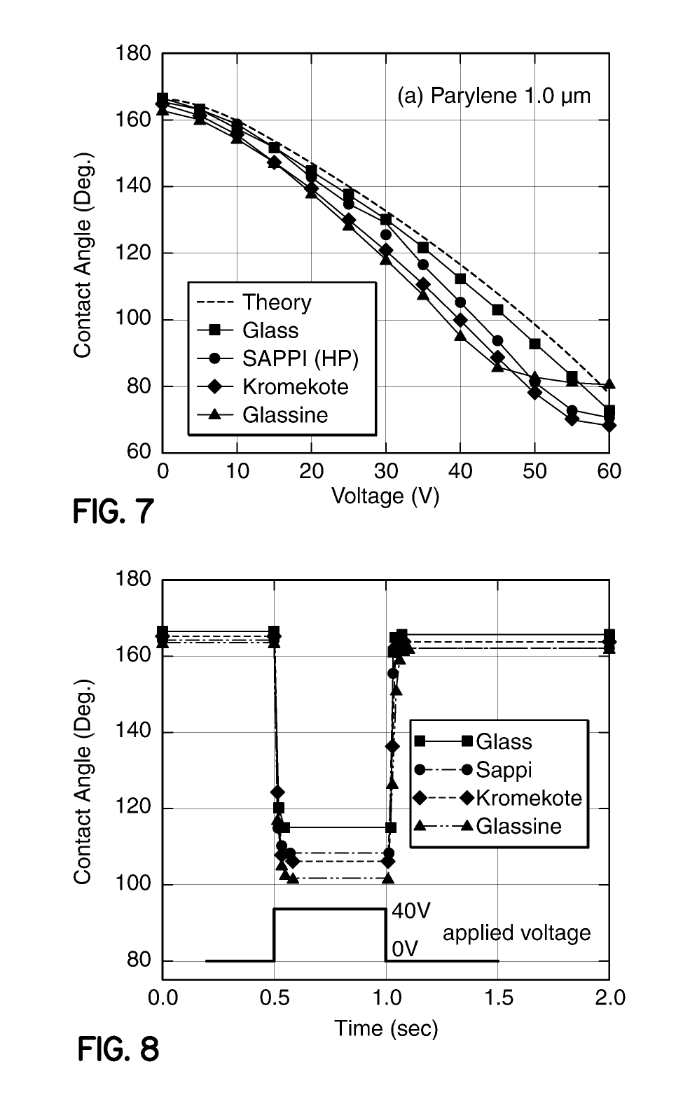

The electrowetting effect was evaluated by measuring the contact angle of the 5 μL droplet of water as a function of DC voltage. To prevent breakdown of the dielectric, the applied voltage did not exceed about 60 V. The resultant changes in the contact angle for the devices of varying substrates are shown in FIG. 7, where the dotted line corresponds to the calculated Young-Lippmann relation:

$$cos θ ( V ) = cos {θ}_{0} + \frac{1}{2 {γ}_{ow}} {CV}^{2} = cos {θ}_{0} + \frac{{ɛ}_{0} {ɛ}_{r}}{2 {γ}_{ow} d} {V}^{2}$$

The Young-Lippmann relation describes the relationship between contact angle and applied voltage, where θ₀ is the contact angle at zero bias, C is the capacitance per unit area, d is the insulator thickness, ∈₀ is the permittivity in a vacuum, ∈ᵣ is the relative dielectric constant of the insulator, γ_{OW} is the surface tension of the oil/water interface, and V is the voltage applied to the water droplet. As shown, the contact angle saturated at 45 V for glassine paper and at 55 V for Kromekote and Sappi paper. The glass substrate did not demonstrate contact angle saturation until about 60 V. The change in contact angle (“ΔCA”) before saturation closely related to the surface roughness of each substrate as expected from the Wenzel model for two-fluid electrowetting. Contact angle saturation also closely related to the surface roughness. While not wishing to be bound by theory, it is believed that this may be attributed to charge trapping, droplet ejection at the contact line, or other previously proposed theories.

Though not shown, the effects of dielectric thickness were also determined. For example, 0.5 μm and 1 μm perylene layers on Sappi paper substrates were tested. The 0.5 μm perylene layer produced greater surface energy at a given applied voltage as compared to the 1 μm parylene layer, which was reflected by a lower contact angle for the thicker dielectric layer.

While not shown, the effects of DC and AC biasing were also tested. In these tests, the 5 μL droplet of deionized water was replaced with a 3 μL droplet of a 0.1 M potassium chloride (“KCl”) solution. For DC biasing, the contact angle decreased with increased voltage, and when the low voltage sweep was reversed, the contact angle recovered to approximately its initial value. However, relatively large hysteresis was observed with larger applied voltage values.

For AC biasing, a 1 kHz square-wave signal was applied to the droplet. A greater ΔCA and much less hysteresis was observed for AC biasing as compared with DC biasing. These observations may be due to the reduced charge injection in the dielectric layer because of a time lag between the applied electric field and the motion of charges within the device. The results for the Sappi paper substrate are summarized in Table 3.

TABLE 3
AC and DC Biasing on Sappi Paper Substrate
with 1.0 μm Parylene Layer

| | Applied Direct | Applied Alternating |
|---|---|---|
| | Current Voltage | Current Voltage |
| Maximum contact angle | 165° at 0 V | 165° at 0 V |
| Minimum contact angle | 72° at 60 V | 66° at 60 V rms |
| ΔCA (deg) | 93° | 99° |
| Hysteresis | 11° at 40 V | 2° at 60 V rms |

The speed with which the water replaces oil under the influence of an applied voltage determines the speed of the associated electrowetting device. Therefore, the switching speed of each device was tested. A 40 V pulse of 500 ms duration and fast (2 ns) rise and fall times was applied to a 3 μL deionized water droplet in dodecane on each manufactured device. The contact angle was captured at 60 frames per second (fps) and the resultant switching times are summarized in Table 4 and shown in FIG. 8. Generally, Kromekote and glassine paper had similar turn-on times but were approximately a factor of 2 slower than Sappi paper and conventional glass substrate designs. While the turn-off time was similar to the turn-on time for Kromekote, the turn-off time for glassine was considerably slower than the turn-on time; both were slower than the Sappi device and the glass device.

TABLE 4
Switching Times

| | On-Time (ms) | Off-Time (ms) |
|---|---|---|
| Glass | 15 | 17 |
| Glassine | 28 | 40 |
| Kromekote | 28 | 29 |
| Sappi | 19 | 19 |

Although the present invention has been described in connection with the specified embodiments, it is not intended to be limited to the specific form set forth herein. Rather, the scope of the present invention is limited only by the accompanying claims. In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. Additional advantages and modifications will readily appear to those skilled in the art. In addition, singular references do not exclude a plurality. Thus, references to “a,” “an,” “first,” “second,” etc. do not preclude a plurality. Furthermore, reference signals in the claims shall not be construed as limiting the scope.

What is claimed is:

1. An electrowetting device comprising:
a paper substrate;
a grounded electrode on one side of the paper substrate;
a dielectric layer on the electrode;
a hydrophobic film on the dielectric, the hydrophobic film configured to impart a contact angle on a polar liquid;
a polar liquid in contact with the hydrophobic film; and
a voltage source coupling the grounded electrode with the polar liquid such that when an electric field is applied by the voltage source, the contact angle of the polar liquid decreases.

2. The electrowetting device of claim 1, wherein the grounded electrode is constructed from copper or indium tin oxide with a thickness that ranges from about 100 nm to about 200 nm.

3. The electrowetting device of claim 1, wherein the dielectric layer is constructed from alumina, silica, or parylene with a thickness that ranges from about 0.5 μm to about 1.0 μm.

4. The electrowetting device of claim 1, wherein the hydrophobic film is constructed from TEFLON, FLUOROPEL, silicone compounds, or a fatty acid with a thickness that ranges from about 100 nm to about 150 nm.

5. The electrowetting device of claim 1 further comprising:
a nonpolar liquid also in contact with the hydrophobic film, wherein the decrease in the contact angle of the polar liquid causes the polar liquid to displace the nonpolar liquid from the hydrophobic film.

6. The electrowetting device of claim 1, wherein the electric field is configured to supply a positive direct current voltage, a negative direct current voltage, or an alternating current from the voltage source.

7. The electrowetting device of claim 1, wherein a thickness of the paper substrate ranges from about 40 μm to about 250 μm.

8. The electrowetting device of claim 1, wherein the polar liquid is deionized water and the contact angle with the hydrophobic film ranges from about 40° to about 110°.

9. The electrowetting device of claim 1, wherein a surface roughness of the paper substrate ranges from about 1.5 nm to about 400 nm.

10. The electrowetting device of claim 1 further comprising:
a plurality of electrowetting cells, each of the plurality of electrowetting cells being surrounded by a photoresist layer on the hydrophobic film; and
a volume of a nonpolar liquid within each of the plurality of electrowetting cells,
wherein the electric field minimizes an amount of contact between the volume of the nonpolar liquid and the hydrophobic film and increases an amount of contact between the polar liquid and the hydrophobic film.

11. The electrowetting device of claim 10, wherein the voltage source is coupled to the polar liquid in each of the plurality of electrowetting cells.

12. The electrowetting device of claim 10, wherein the voltage source is comprised of a plurality of voltage sources, each of the plurality of voltage sources being coupled to the polar liquid of a respective one of the plurality of electrowetting cells.

13. An electrowetting device comprising:
a paper dielectric having opposing first and second sides;
a grounded electrode on the first side of the paper dielectric;
a hydrophobic film on the second side of the paper dielectric, the hydrophobic film configured to impart a contact angle on a polar liquid;
a polar liquid in contact with the hydrophobic film; and
a voltage source coupling the grounded electrode with the polar liquid such that when an electric field is applied by the voltage source the contact angle of the polar liquid decreases.

14. The electrowetting device of claim 13, wherein the copper or indium tin oxide electrode has a thickness that ranges from about 100 nm to about 200 nm.

15. The electrowetting device of claim 13, wherein the hydrophobic film is constructed from TEFLON, FLUOROPEL, silicone compounds, or a fatty acid with a thickness that ranges from about 100 nm to about 150 nm.

16. The electrowetting device of claim 13 further comprising:
a nonpolar liquid also in contact with the hydrophobic film, wherein the decrease in the contact angle of the polar liquid causes the polar liquid to displace the nonpolar liquid from the hydrophobic film.

17. The electrowetting device of claim 13, wherein the electric field is configured to supply a positive direct current voltage, a negative direct current voltage, or an alternating current voltage from the voltage source.

18. The electrowetting device of claim 13, wherein a thickness of the paper dielectric ranges from about 40 μm to about 250 μm.

19. The electrowetting device of claim 13 further comprising:
a plurality of electrowetting cells, each of the plurality of electrowetting cells being surrounded by a photoresist layer on the hydrophobic film; and
a volume of a nonpolar liquid within each of the plurality of electrowetting cells,
wherein the electric field minimizes an amount of contact between the volume of the nonpolar liquid and the hydrophobic film and increases an amount of contact between the polar liquid and the hydrophobic film.

20. The electrowetting device of claim 19, wherein the voltage source is comprised of a plurality of voltage sources, each of the plurality of voltage sources being coupled to the polar liquid of a respective one of the plurality of electrowetting cells.

21. A method of constructing an electrowetting device on a paper substrate, the method comprising:
depositing an electrode on one side of the paper substrate;
forming a dielectric layer on the electrode;
coating a hydrophobic film onto the dielectric layer;
placing a polar liquid in contact with the hydrophobic film; and
forming an electrical connection between the polar liquid and the electrode, the electrode being grounded.

22. The method of claim 21 further comprising:
annealing the hydrophobic film before placing the polar liquid in contact with the hydrophobic film.

23. The method of claim 21, wherein depositing the electrode includes sputter deposition of copper or indium tin oxide onto the one side of the paper substrate to a thickness that ranges from about 100 nm to about 200 nm.

24. The method of claim 21, wherein forming the dielectric layer includes forming a layer of alumina, silica, or parylene on the electrode to a thickness that ranges from about 0.5 μm and about 1.0 μm.

25. The method of claim 21, wherein coating the hydrophobic film includes coating TEFLON, FLUOROPEL, silicone compounds, or a fatty acid onto the dielectric layer to a thickness that ranges from about 100 nm to about 150 nm.

26. The method of claim 21, wherein the electrical connection is configured to supply a positive direct current voltage, a negative direct current voltage, or an alternating current voltage from a voltage source.

27. The method of claim 21 further comprising:
placing a nonpolar liquid in contact with the hydrophobic film.

28. A method of constructing an electrowetting device having a paper dielectric, the method comprising:
depositing an electrode on a first side of the paper dielectric;
coating a hydrophobic film on a second side of the paper dielectric;
placing a polar liquid in contact with the hydrophobic film; and
forming an electrical connection between the polar liquid and the electrode, the electrode being grounded.

29. The method of claim 28 further comprising:
annealing the hydrophobic film before placing the polar liquid in contact with the hydrophobic film.

30. The method of claim 28, wherein depositing the electrode includes sputter deposition of copper or indium tin oxide onto the one side of the paper substrate to a thickness that ranges from about 100 nm to about 200 nm.

31. The method of claim 28, wherein coating the hydrophobic film includes coating TEFLON, FLUOROPEL, silicone compounds, or a fatty acid onto the dielectric layer to a thickness that ranges from about 100 nm to about 150 nm.

32. The method of claim 28, wherein the electrical connection is configured to supply a positive direct current voltage, a negative direct current voltage, or an alternating current voltage from a voltage source.

33. The method of claim 28 further comprising:
placing a nonpolar liquid in contact with the hydrophobic film.

34. An electrowetting display device comprising:
a paper substrate;
a grounded electrode on one side of the paper substrate;
a dielectric layer on the electrode;
a hydrophobic film on the dielectric, the hydrophobic film configured to impart a contact angle on a polar liquid;
a masked photoresist layer on the hydrophobic film forming a plurality of pixels;
a plurality of volumes of a polar liquid, wherein each of the plurality of volumes is positioned in a respective one of the plurality of pixels; and
a voltage source coupling the grounded electrode with the at least one of the plurality of volumes of the polar liquid such that when an electric field is applied by the voltage source, the contact angle of the at least one of the plurality of volumes decreases.

35. The electrowetting display device of claim 34, wherein the voltage source comprises a plurality of voltage sources, each of the plurality of voltage sources being electrically coupled to a different one of the plurality of volumes.

36. An electrowetting display device comprising:
a paper dielectric having opposing first and second sides;
a grounded electrode on the first side of the paper dielectric;
a hydrophobic film on the second side of the paper dielectric, the hydrophobic film configured to impart a contact angle on a polar liquid;
a masked photoresist layer on the hydrophobic film forming a plurality of pixels;
a plurality of volumes of a polar liquid, wherein each of the plurality of volumes is positioned in a respective one of the plurality of pixels; and
a voltage source coupling the grounded electrode with the at least one of the plurality of volumes of the polar liquid such that when an electric field is applied by the voltage source, the contact angle of the at least one of the plurality of volumes decreases.

37. The electrowetting display device of claim 36, wherein the voltage source comprises a plurality of voltage sources, each of the plurality of voltage sources being electrically coupled to a different one of the plurality of volumes.

38. A method of constructing an electrowetting display device on a paper substrate, the method comprising:
depositing an electrode on one side of the paper substrate;
forming a dielectric layer on the electrode;
coating a hydrophobic film onto the dielectric layer;
depositing a photoresist layer onto the hydrophobic film;
masking and developing the photoresist layer to form a plurality of pixels;
placing a volume of a polar liquid in each one of the plurality of pixels and in contact with the hydrophobic film; and
forming an electrical connection between at least one of the volumes of the polar fluid and the electrode, the electrode being grounded.

41. A method of constructing an electrowetting display device having a paper dielectric, the method comprising:
depositing an electrode on a first side of the paper dielectric;
coating a hydrophobic film on a second side of the paper dielectric;
depositing a photoresist layer onto the hydrophobic film;
masking and developing the photoresist layer to form a plurality of pixels;
placing a volume of a polar liquid in each one of the plurality of pixels and in contact with the hydrophobic film; and
forming an electrical connection between at least one of the volumes of the polar liquid and the electrode, the electrode being grounded.
